(19) United States
(12) Patent Application Publication
(10) Pub. No.: US 2011/0259482 A1
(43) Pub. Date: Oct. 27, 2011

(54) Use of a Steel Alloy for Well Pipes for Perforation of Borehole Casings, and Well Pipe

(75) Inventors: Andreas Peters, Dusseldorf (DE); Rolf Trittel, Gelsenkirchen (DE); Christopher Halfpap, Diepholz (DE)

(73) Assignee: Benteler Stahl/Rohr GmbH, Paderborn (DE)

(21) Appl. No.: 12/600,126

(22) PCT Filed: May 16, 2008
(86) PCT No.: PCT/EP08/03961

§ 371 Date: Mar. 11, 2011

(30) Foreign Application Priority Data
May 16, 2007 (DE) 102007023306.1

(51) Int. Cl. C21D 9/08; C22C 38/46; C22C 38/48; C22C 38/50; C22C 38/54; C22C 38/58; C22C 38/22; C22C 38/24; C22C 38/26; C22C 38/28; C22C 38/32; C22C 38/38; C22C 38/02; F16L 9/02; C22C 38/44

(52) U.S. Cl. 148/590; 148/330; 138/177

(57) ABSTRACT

Use of a steel alloy for well pipes of perforating units for perforation of borehole casings, with the steel alloy comprised, in mass-%, of Carbon (C) 0.12-0.25, Manganese (Mn) 0.5-2.0, Silicon (Si) 0.1-0.5, Nitrogen (N) 0.006-0.015, Sulfur (S) <0.005, Chromium (Cr) 0.1-1.5, Molybdenum (Mo), <0.3, Nickel (Ni) <1.0, Vanadium (V) <0.25, Niobium (Nb) 0.010-0.15, Titanium (Ti) 0.02-0.06, Boron (B) 0.001-0.006, Calcium (Ca) <0.0025, and iron as well as impurities resulting from smelting as remainder, wherein the steel alloy is heated at a heating rate of 1-100 K/s to an austenitizing temperature between 10 to 50° C. above its transformation temperature Ac3, and held at this austenitizing temperature between 0.1 and 10 minutes and austenitized, subsequently quenched at a quenching rate of >50K/s, so as to adjust a martensite content of >95%, wherein the remainder is formed of lower bainite, wherein the structure is then tempered starting from room temperature between 1 and 25 minutes at temperatures between 280° C. and 700° C., and finally cooled in air or quenched in water to room temperature, wherein the steel has a tensile strength Rm ranging from 600 MPa to 1,350 MPa at transverse notch impact toughnesses in a range between 210 and 70 J/cm² at room temperature, wherein the product of tensile strength and transverse notch impact toughness lies in the strength range between 750 MPa and 1,200 MPa in a range of 141,000 to 165,000 MPa*J/cm².

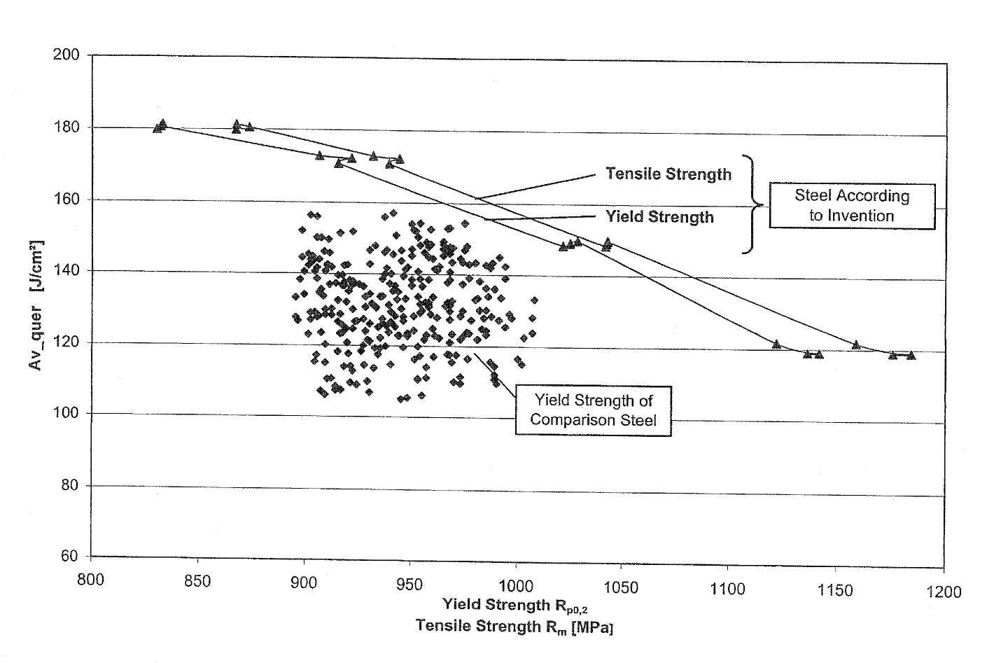

Perforation units or so-called “perforating guns” are used for opening or renewed opening of boreholes for exploration of liquid or gaseous energy carriers, i.e. for exploration of gas or crude oil, and are made from a well pipe which accommodates an explosive unit. The explosive unit normally includes several hollow charges as well as the necessary ignition electronics. As the explosive charges are ignited in the respective crude-oil-carrying or natural-gas-carrying layer, holes are formed in the well pipe, in the pipe liner arranged in the borehole, and the cement normally filled behind the pipe liner. The natural-gas-guiding or crude-oil-guiding rock formation outside the cement wall of the borehole is perforated by a plasma beam (jet) of the explosive charge so that the crude oil or the natural gas can be introduced via the perforations and holes in the pipe liner into the borehole and discharged upwards.

The well pipes of the perforation units must withstand before use, i.e. during lowering and positioning, in the region of the respective crude-oil-carrying or natural-gas-carrying layer high mechanical stress in the form of high pressure as well as sometimes elevated temperatures that may reach above 266° C. This requires that the well pipes have a narrow tolerance with respect to their geometric shape, exhibit only a slight eccentricity, and moreover are made of a material of high strength. The yield point should generally range above 600 MPa. Oftentimes, yield points of greater than 890 MPa are required to prevent the collapse of the perforation unit.

During the use of the perforation unit, the high internal pressures which develop, when the explosive charges ignite, demand a high strength, especially a high toughness and in particular a transverse notch impact toughness in order to prevent the well pipe from bursting as a consequence of an uncontrolled crack growth during explosion. The used materials must therefore exhibit a high strength and at the same time also a good toughness.

Exploration of increasingly deeper fossil fuel deposits and the desire to equip perforation units increasingly with stronger explosive charges to create larger and deeper boreholes presupposes that the well pipes are provided of significantly better strength and toughness properties compared to those known from the state of the art and currently available.

The demand for high strength with sufficient toughness at the same time can be basically met using quenched and tempered steels which have a carbon content in the range of 0.25% to 0.45%. These steels normally contain further alloying elements, such as, e.g., chromium, molybdenum and nickel which in particular provide optimum capacity for full quenching and tempering.

Quenching and tempering treatment, i.e. hardening and tempering, produces steels with a martensitic structure to realize the wanted combination of strength and toughness as a result of their even and fine microstructure. The strength demanded from the respective component and thus from the material is primarily adjusted by the temperature selection for tempering. Lower tempering temperatures result basically in increased final strength of the material. The rise in strength is accompanied, however, by a decrease in toughness and reduction in ductility. Strength and toughness behave in opposition to one other in metal-physical sense. In other words, the increase in strength set in a material gets higher, for example through selection of a lower tempering temperature is accompanied by a decrease in toughness and ductility. Therefore, there are limits to satisfy the desire for high strength and good toughness properties at the same time.

Many measures were developed and implemented during steel production to produce high-strength steel materials with sufficient toughness at the same time. Enhancements of the metallurgical degree of purity of the materials, production of structures with little segregation and assurance of a fine initial structure before austenitizing are considered among others. The latter is of crucial importance because for metal-physical reasons only fineness of the respective product structure is able to realize a strength increase as well as simultaneously an increase in toughness. All other strength enhancing mechanisms, e.g. solid solution hardening, cold solidification, or precipitation hardening, generally have a toughness-reducing effect.

By optimizing the alloy composition, the steel production process, the hot-rolling conditions, and the final quenching and tempering treatment, a quenched and tempered steel can be produced for example which contains about 0.3% of carbon, 1.0% of chromium, and 0.2% of molybdenum and a remainder of iron and impurities resulting from smelting, and exhibits a tensile strength of 950 MPa and a transverse notch impact toughness of 130 J/cm². The thus described level of strength and toughness reflects the quality potential attainable for this material classification. An improved quality potential cannot be realized for this frequently employed material process with the necessary process reliability, even when further optimizing the afore-mentioned production conditions

The prior art to U.S. Pat. No. 2,586,041 discloses a steel alloy which contains 0.22 to 0.37 of carbon, 0.65 to 0.95% of manganese, 0.6 to 0.8% of silicon, 0.7 to 0.9% of chromium, 0.4 to 0.6% of molybdenum, 0.7 to 0.95% of nickel, and 0.003 to 0.006% of boron, remainder iron and impurities resulting from smelting, and is subjected to a heat treatment which involves a quenching from a temperature above Ac3 and tempering at 204 to 260° C. of the steel for formation of a martensitic structure. In this way, a toughness of more than 20 ft.-lbs (=33.9 J/cm²) at a temperature of −73° C. should be ascertained by a notched bar impact bend test. At the same time, the tensile strength Rm should be greater than 220,000 p.s.i. (=1,516 MPa). The product of tensile strength and notch impact energy reaches a value of 5,205 ksi*ft.-lbs. Such high-strength steel is intended, for example, for application in landing gears of airplanes, for drill tips of pneumatic drilling tools, and for perforating guns. The steel is characterized primarily by a very high strength. Its toughness at low temperatures is, however, a property which remains ineffective in perforating guns as a result of the significantly higher thermal stress within a borehole. The toughness (28 ft.-lbs=about 47.5 J/cm²) measured at room temperature is relatively small.

The desired tempering temperatures between 204 and 260° C. may further adversely affect the inherent residual stress, in particular when tempering operations have not been entirely completed. Even though this steel alloy has an alloying content of below 4%, the lower limit is calculated at 3.22% so that the alloy is very expensive by today's standards, especially because of the high proportion of molybdenum and nickel.

The invention is based on the object to provide a steel alloy for making well pipes of perforation units for perforation of boreholes as well as well pipes made of such a steel alloy, with the steel alloy having strength and toughness behaviors which, compared to the state of the art, can be better suited to the application at hand, and wherein the property profile is moreover attained with a cost-efficient alloy.

The object is solved by the use of a quenched and tempered steel alloy according to the chemical composition set forth in patent claims 1 and 13.

The respectively dependent patent claims set forth advantageous configurations of the inventive idea that are not self-evident.

It is proposed for producing well pipes of perforation units for perforation of borehole casings to use a steel which has a carbon content below 0.25%, however not below 0.12%, and which has a manganese content of 0.5% to 2.0%, admixtures of niobium, titanium, and boron, and may contain the supportive elements nickel, chromium, molybdenum, and vanadium, at a nitrogen content of at least 0.006% and maximal 0.015% and which is subjected to a material-specific quenching and tempering treatment.

Carbon required for formation of martensite is lowered in the used steel alloy to a value between 0.12% to 0.25% so as to ensure the formation of lath martensite instead of plate martensite, on one hand, and to attain the desired target strength, on the other hand. Target strength is to be understood as relating to the yield point which may lie above 930 MPa, when suitably heat treated. The yield point of the well pipes should lie at least above 895 MPa at tensile strengths of at least 930 MPa. At the same time, a transverse notch impact toughness of above 105 J/cm² at room temperature is adjusted.

The alloying element manganese is added by alloying to assist the solid solution strengthening so that a portion of the carbon content required for attaining high strength values is compensated. Important for the application of the steel is the use of manganese to promote the capacity for full quenching and tempering of the well pipes. The elements titanium and boron also assist in attaining a capacity for full quenching and tempering as well as a further improvement of the toughness of the steel material.

Titanium serves in this context in particular the fixation of nitrogen occurring in steel in order to fully develop the effect of the element boron to enhance hardenability.

A controlled but not necessary admixture of nickel, chromium, molybdenum or vanadium may assist in the formation of a fine structure, so that the toughness of the material can further be increased.

To realize a fine starting structure before martensitic transformation, it has been shown especially advantageous when the total of titanium, niobium and vanadium has a minimum value of 0.03 and 0.08%. This ensures that the grain growth during austenitizing is limited as a consequence of sufficient formation of fine precipitation, and the tendency for embrittlement, known in the literature, is prevented when admixing micro-alloying elements in lean stoichiometric environment.

The elements molybdenum, nickel and chromium further promote the capacity for full quenching and tempering of the material.

In order to positively influence in particular the transverse notch impact toughness, it is targeted to limit the maximum sulfur content of the steel to 0.005% and to alloy the steel with max. 25 ppm, preferably between 8 and 25 ppm, of calcium. As a result, precipitations of toughness-reducing aluminum oxide from the secondary metallurgy are finely dispersed in steel and do not cause unwanted instable crack propagation in particular when exposed to sudden stress.

Preferably used for manufacturing well pipes is a steel alloy which contains 0.15% to 0.22% of carbon, 1.3% to 1.8% of manganese, 0.2% to 0.4% of silicon, 0.006 to 0.012% of nitrogen, 0.1% to 0.3% of chromium, less than 0.1% of molybdenum, less than 0.1% of nickel, less than 0.05% of vanadium, 0.01 to 0.05% of niobium, 0.02% to 0.04% of titanium, 0.0015% to 0.003% of boron, 0.0008 and 0.0020% of Ca, and iron as well as impurities resulting from smelting as remainder.

The quenching and tempering treatment of the steel alloy first involves austenitizing to a temperature above the material-specific transformation temperature Ac3 over a time period of 0.1 to 10 minutes. Austenitizing preferably takes place over a time period between 0.1 and 5 minutes. The austenitizing temperature preferably lies in a range of 25° C.+/−5° C. above the transformation temperature Ac3. The exact temperature depends on the heating rate which is very high, when inductive heating is involved. The heating rate lies in a range between 1 and 50 K/s. This is followed by a quenching treatment in a medium which ensures sufficient cooling rate for the material and dimensions of the workpiece and results in the formation of more than 95% martensite, remainder lower bainite. The quenching medium is preferably water. The quenching rate should range between 60 and 500 K/s. The quenched material is then heated starting from room temperature and tempered over a time period of 1 to 25 minutes, preferably between 5 and 15 minutes, at a temperature range between 280° C. and 700° C., whereby the selected temperature and temperature profile depend in the required target strength. Finally, the material is cooled in air or quenched in water to room temperature.

The well pipes produced from the mentioned steel alloy and the described quenching and tempering process have outer diameters ranging from 30 to 180 mm at wall thicknesses of 6 to 20 mm.

The transverse notch impact toughness A [J/cm²] is plotted by way of example for a pipe having an outer diameter of 73.4 mm at a wall thickness of 9.2 mm and made from the steel according to the invention in quenched and tempered state, i.e. after austenitizing over 5 minutes at 920° C., quenching in water, and tempering at different temperatures between 450 and 610° C., at tempering times of less than 10 minutes, as a function of the respective mechanical parameters, i.e. toughness Rm and yield strength Rp0.2. At the same time, the range of common mechanical-technological properties of a conventional quenched and tempered steel is depicted. This comparison steel has the following chemical composition:

| | |
|---|---|
| Carbon | 0.31% |
| Manganese | 0.75% |
| Chromium | 1.00% |
| Molybdenum | 0.18% |
| Nickel | 0.14% |

remainder iron and impurities resulting from smelting.

The steel according to the invention has following composition:

| | |
|---|---|
| Carbon | 0.16% |
| Silicon | 0.31% |
| Nitrogen | 0.0088% |
| Sulfur | 0.0021% |
| Manganese | 1.40% |
| Chromium | 0.19% |
| Vanadium | 0.005% |
| Nickel | 0.08% |
| Molybdenum | 0.03% |
| Titanium | 0.037% |
| Niobium | 0.039% |
| Boron | 0.0017% |
| Ca | 0.0012% |

remainder iron and impurities resulting from smelting.

As can be seen in the illustration, the tensile strength and yield strength of the steel according to the invention at a certain transverse notch impact toughness is greater than the tensile strength and yield strength of the comparison steel ascertained by many tests. Just like the steel used in the invention, the comparison steel meets the demand for s yield strength above 895 MPa and a transverse notch impact toughness above 105 J/cm². The characteristic material values of the comparison steel exceed, however, only rarely the yield strengths of above 1,000 MPa at transverse notch impact toughnesses which mostly lie below 150 J/cm².

Conversely, the used steel has the property of being especially solid and at the same time sufficiently tough for the special application at hand because its characteristic material values include transverse notch impact toughnesses of above 160 J/cm² at yield strengths of above 900 MPa. Likewise, the steel used in the invention can be adjusted through suitable heat treatment to a yield strength of above 1,000 MPa. In an extreme case, this exemplary material has reached yield strengths of up to 1,142 MPa at a transverse notch impact toughness of 119 J/cm². In particular the last value pair underscores that the used steel excels in meeting the requirements demanded of well pipes of perforation units for perforation of borehole casings. The heat treatment is hereby modified in particular by changing the tempering temperature. For example, the tensile strength of 850 MPa has been realized at a tempering temperature of 610° C., while the tensile strength of about 1,200 MPa has been realized at a tempering temperature of 450° C.

The correlation between toughness and strength can be described for predefined upper and lower limits of these characteristic material values by the mathematical product of these characteristic values. The product of tensile strength and transverse notch impact toughness should range from 141,000 to 165,000 MPa*J/cm² for the steel alloy according to the invention at room temperature in the strength range between 750 MPa and 1,200 MPa. The transverse notch impact toughness Av_quer may also be expressed as function of the yield strength (Rp0.2). The steel alloy used in accordance with the invention has the following correlation:

$$Av\_quer [ J \text{/} {cm}^{2} ] = - {3.7679}^{*} {{10}^{- 4 *} [ Rp 0.2 in MPa ]}^{2} + {5.3809}^{*} {{10}^{- 1 *} [ Rp 0.2 in MPa ]}^{2} - 5.9505 .$$

The coefficient of determination R² lies above 99% so that the used steel alloy realizes the targeted material properties at very high process reliability.

The crucial factor for reaching the desired material parameters is a heat treatment that is suited to the material so that the structure can be produced with the desired composition. In particular, the martensite portion of the structure should lie above 95%, comprised of >85% lath martensite and <15% plate martensite. The remainder of the structure is formed of lower bainite.

In order to utilize the high potential of the steel according to the invention for reliably realizing an optimum strength-toughness ratio, it has been shown especially advantageous to interrupt quenching below the martensitic end temperature (Mf), before the material is cooled down to room temperature. As a consequence, thermal stress in the structure is kept as small as possible so that toughness-reducing crack formation is again prevented in the microstructure of the alloy.

A well pipe for perforating guns is made from a seamlessly produced tube round which is subjected to the heat treatment set forth in patent claim 13. The tube round can then be supplied, of course, to a further material removing treatment to adjust the desired end geometry.

1. A steel alloy for well pipes of perforating units for perforation of borehole casings, comprising, in mass-%,

| | |
|---|---|
| Carbon (C) | 0.12-0.25 |
| Manganese (Mn) | 0.5-0.2 |
| Silicon (Si) | 0.1-0.5 |
| Nitrogen (N) | 0.006-0.015 |
| Sulfur (S) | <0.005 |
| Chromium (Cr) | 0.1-1.5 |
| Molybdenum (Mo) | <0.3 |
| Nickel (Ni) | <1.0 |
| Vanadium (V) | <0.25 |
| Niobium (Nb) | 0.010-0.15 |
| Titanium (Ti) | 0.02-0.06 |
| Boron (B) | 0.001-0.006 |
| Calcium (Ca) | <0.0025 |

and iron as well as impurities resulting from smelting as remainder, wherein the steel alloy is heated at a heating rate of 1-100 K/s to an austenitizing temperature between 10 to 50° C. above its transformation temperature Ac3, and held at this austenitizing temperature between 0.1 and 10 minutes and austenitized, subsequently quenched at a quenching rate of >50K/s, so as to adjust a martensite content of >95%, wherein the remainder is formed of lower bainite to thereby produce a structure, wherein the structure is then tempered starting from room temperature between 1 and 25 minutes at temperatures between 280° C. and 700° C., and finally cooled in air or quenched in water to room temperature, wherein the steel has a tensile strength Rm ranging from 600 MPa to 1,350 MPa at transverse notch impact toughnesses in a range between 210 and 70 J/cm² at room temperature, wherein the product of tensile strength and transverse notch impact toughness lies in the strength range between 750 MPa and 1,200 MPa in a range of 141,000 to 165,000 MPa*J/cm².

2. The steel alloy of claim 1, wherein the steel alloy comprises, in mass-%,

| | |
|---|---|
| Carbon (C) | 0.15-0.22 |
| Manganese (Mn) | 1.3-1.8 |
| Silicon (Si) | 0.2-0.4 |
| Nitrogen (N) | 0.006-0.012 |
| Sulfur (S) | <0.003 |
| Chromium (Cr) | 0.1-0.3 |
| Molybdenum (Mo) | <0.1 |
| Nickel (Ni) | <0.1 |
| Vanadium (V) | <0.05 |
| Niobium (Nb) | 0.01-0.05 |
| Titanium (Ti) | 0.02-0.04 |
| Boron (B) | 0.0015-0.003 |
| Calcium (Ca) | 0.0008-0.0020 |

and iron as well as impurities resulting from smelting as remainder, wherein the well pipe has a tensile strength Rm ranging from 850 MPa to 1,200 MPa at transverse notch impact toughnesses in a range between 190 and 105 J/cm² at room temperature.

3. The steel alloy of claim 1, wherein the alloy satisfies the totals formulas Ti+Nb+V>0.03 and Ti+Nb+V<0.08.

4. The steel alloy of claim 1, wherein a titanium/nitrogen ratio ranges between 3.4 and 5.

5. The steel alloy of claim 1, wherein the heating rate ranges from 1 to 50 K/s.

6. The steel alloy of claim 1, wherein the heating is inductive.

7. The steel alloy of claim 1, wherein the austenitizing temperature ranges from 25° C.+/−5° C. above the transformation temperature Ac3.

8. The steel alloy of claim 1, wherein the steel alloy is austenitized over a time period between 0.1 and 5 minutes.

9. The steel alloy of claim 1, wherein the quenching rate ranges from 60 to 500 K/s after austenitizing.

10. The steel alloy of claim 1, wherein the quenching operation is interrupted when the martensite finish temperature (Mf) falls below by at most 50° C.

11. The steel alloy of claim 1, wherein the structure is comprised of >85% lath martensite, <15% plate martensite, remainder bainite.

12. The steel alloy of claim 1, wherein the steel alloy is tempered between 1 and 12 minutes.

13. A method of producing a well pipe of a perforation unit for perforation of borehole casings, comprising the steps of:
a) preparing a seamless tubular body of a steel alloy comprising, in mass-%,

| | |
|---|---|
| Carbon (C) | 0.12-0.25 |
| Manganese (Mn) | 0.5-2.0 |
| Silicon (Si) | 0.1-0.5 |
| Nitrogen (N) | 0.006-0.015 |
| Sulfur (S) | <0.005 |
| Chromium (Cr) | 0.1-1.5 |
| Molybdenum (Mo) | <0.3 |
| Nickel (Ni) | <1.0 |
| Vanadium (V) | <0.25 |
| Niobium (Nb) | 0.010-0.15 |
| Titanium (Ti) | 0.02-0.06 |
| Boron (B) | 0.001-0.006 |
| Calcium (Ca) | <0.0025 |

and iron as well as impurities resulting from smelting as remainder,
b) heating the tubular body at a heating temperature of 1-100 K/s to an austenitizing temperature between 10 to 50° C. above its transformation temperature Ac3,
c) holding at this austenitizing temperature between 0.1 and 10 minutes for austenitizing,
d) subsequently quenching at a quenching rate of >50K/s, so as to adjust a martensite content of >95%, wherein the remainder of the structure is formed of lower bainite,
e) tempering the tubular body starting from room temperature over a time period of 1 and 25 minutes at temperatures ranging from 280° C. and 700° C., and
f) cooling the tubular body in air or quenching in water to room temperature, so that the tubular body has a tensile strength Rm ranging from 600 MPa to 1,350 MPa at transverse notch impact toughnesses in a range between 210 and 70 J/cm² at room temperature, and wherein the product of tensile strength and transverse notch impact toughness lies in the strength range between 750 MPa and 1,200 MPa in a range of 141,000 to 165,000 MPa*J/cm².

14. The method of claim 13, wherein the tubular body is producible from a steel alloy which comprises, in mass-%,

| | |
|---|---|
| Carbon (C) | 0.15-0.22 |
| Manganese (Mn) | 1.3-1.8 |
| Silicon (Si) | 0.2-0.4 |
| Nitrogen (N) | 0.006-0.012 |
| Sulfur (S) | <0.003 |
| Chromium (Cr) | 0.1-0.3 |
| Molybdenum (Mo) | <0.1 |
| Nickel (Ni) | <0.1 |
| Vanadium (V) | <0.05 |
| Niobium (Nb) | 0.01-0.05 |
| Titanium (Ti) | 0.02-0.04 |
| Boron (B) | 0.0015-0.003 |
| Calcium (Ca) | 0.0008-0.0020 |

and iron as well as impurities resulting from smelting as remainder, wherein the tubular body has a tensile strength Rm ranging from 850 MPa to 1,200 MPa at transverse notch impact toughnesses in a range between 190 and 105 J/cm² at room temperature.

15. The method of claim 13, wherein the totals formulas are satisfied: Ti+Nb+V>0.03 and Ti+Nb+V<0.08.

16. The method of claim 13, wherein the titanium/nitrogen ratio T/N ranges between 3.4 and 5.

17. The method of claim 13, wherein the heating rate is selected in a range from 1 to 50 K/s.

18. The method of claim 13, wherein the heating is inductive.

19. The method of claim 13, wherein the austenitizing temperature is selected in a range from 25° C.+/−5° C. above the transformation temperature Ac3.

20. The method of claim 13, wherein the steel alloy is austenitized over a time period between 0.1 and 5 minutes.

21. The method of claim 13, wherein the quenching rate is selected in a range from 60 to 500 K/s after austenitizing.

22. The method of claim 13, wherein the quenching operation is interrupted, when the martensite finish temperature (Mf) falls below by not more than 50° C.

23. The method of claim 13, wherein the structure is comprised of >85% lath martensite, <15% plate martensite, remainder bainite.

24. The method of claim 13, wherein the steel alloy is tempered between 1 and 12 minutes.

25. A well pipe of a perforation unit for perforation of borehole casings, comprising a seamless tubular body of a steel alloy comprising, in mass-%,

| | |
|---|---|
| Carbon (C) | 0.12-0.25 |
| Manganese (Mn) | 0.5-2.0 |
| Silicon (Si) | 0.1-0.5 |
| Nitrogen (N) | 0.006-0.015 |
| Sulfur (S) | <0.005 |
| Chromium (Cr) | 0.1-1.5 |
| Molybdenum (Mo) | <0.3 |
| Nickel (Ni) | <1.0 |
| Vanadium (V) | <0.25 |
| Niobium (Nb) | 0.010-0.15 |
| Titanium | 0.02-0.06 |
| Boron (B) | 0.001-0.006 |
| Calcium (Ca) | <0.0025 |

and iron as well as impurities resulting from smelting as remainder, wherein the tubular body has a tensile strength Rm ranging from 850 MPa to 1,200 MPa at transverse notch impact toughness in a range between 190 and 105 J/cm² at room temperature.
